(19) United States
(12) Patent Application Publication
(10) Pub. No.: US 2021/0064082 A1
(43) Pub. Date: Mar. 4, 2021

(54) WAVEGUIDE AUGMENTED REALITY DISPLAY APPARATUS

(71) Applicant: AAC Optics Solutions Pte. Ltd., Singapore city (SG)

(72) Inventor: Meng Yang, Shenzhen (CN)

(21) Appl. No.: 17/004,011

(22) Filed: Aug. 27, 2020

(30) Foreign Application Priority Data
Aug. 28, 2019 (CN) 201910803524.7

(51) Int. Cl. G06F 1/16; F21V 8/00; G02B 5/30

(52) U.S. Cl. CPC G06F 1/1609; G02B 5/3025; G02B 6/0075

(57) ABSTRACT

The present disclosure relates to a waveguide augmented reality display apparatus, including: an image source for displaying an image and generating a first light beam and a second light beam with different optical properties according to data of the displayed image; a single waveguide spaced from the image source; a first in-coupling device and a second in-coupling device arranged on the waveguide away for coupling the first light beam and the second light beam into the waveguide respectively; and an out-coupling device, arranged on the waveguide for coupling out the first light beam and the second light beam propagating in the waveguide in a same preset area. The apparatus can realize the superposition of two different fields of view through a single waveguide, significantly increase the field of view on the premise of ensuring the compact structure of the apparatus, and is conducive to improving the user experience.

### TECHNICAL FIELD

The present disclosure relates to the optical technology, in particular to a waveguide augmented reality display apparatus.

### BACKGROUND

Augmented reality technology is also referred to as AR. AR augmented reality technology is a relatively new technical solution that promotes the fusion of real world information and virtual world information. It simulates and processes the physical information that is difficult to experience in the real world space by using computers and other scientific technologies, and superimposes the virtual information content in the real world, which may be perceived by human senses in this process, thus realizing a sensory experience beyond reality. After the real environment and virtual objects overlap, they may exist in the same picture and space at the same time. Augmented reality display technology may superimpose virtual images into the real world to achieve the purpose of fusing virtual information with the real world. Augmented reality display technology can enhance the information expressed in the real world, so it has broad application prospects in education, remote cooperation, traffic navigation and other fields. The waveguide-based augmented reality display apparatus has the advantages of compact structure, small size and easy for the exit pupil to expand, and has been used in products by Microsoft, Sony, Magicleap and other companies.

Due to the limitation of total reflection condition of waveguide, the field of view of waveguide-based augmented reality display apparatus is generally small. The traditional waveguide augmented reality display apparatus is usually provided with two waveguides, one waveguide is used to transmit a light beam generated by an image source according to image data of a left half of a displayed image, and the other waveguide is used to transmit a light beam generated by an image source according to image data of a right half of the displayed image, so as to enhance the field of view. However, the dual-waveguide configuration increases the thickness and weight of the waveguide augmented reality display apparatus, which greatly reduces the user experience of the waveguide augmented reality display apparatus.

### SUMMARY

Therefore, it is necessary to provide a waveguide augmented reality display apparatus which may increase a field of view and has a compact structure.

A waveguide augmented reality display apparatus, includes:

an image source, configured to display an image and generate a first light beam and a second light beam with different optical properties according to data of the displayed image;

a single waveguide spaced from the image source;

a first in-coupling device, arranged on one side of the waveguide adjacent to the image source, and configured to couple the first light beam into the waveguide;

a second in-coupling device, arranged on one side of the waveguide away from the image source, and configured to couple the second light beam into the waveguide, wherein both the first light beam and the second light beam are originated from a light beam generated by the image source according to the data of a same displayed image; and

an out-coupling device, arranged on the waveguide, and configured to couple out the first light beam and the second light beam propagating in the waveguide in a same preset area; wherein an out-coupling grating vector of the first light beam and an out-coupling grating vector of the second light beam are the same.

In one embodiment, the first light beam is a light beam of a first polarization state, the second light beam is a light beam of a second polarization state, the waveguide augmented reality display apparatus further includes a first polarizer and a second polarizer, and the first polarizer and the second polarizer are configured to screen the light beam to obtain a light beam of the first polarization state and a light beam of the second polarization state respectively.

In one embodiment, the light beam of the first polarization state and the light beam of the second polarization state are a light beam of an S polarization state and a light beam of a P polarization state, or a light beam of a left-handed circular polarization state and a light beam of a right-handed circular polarization state, respectively.

In one embodiment, the first polarizer and the second polarizer are arranged in parallel on one side of the image source adjacent to the waveguide, and an orthographic projection of the first polarizer and an orthographic projection of the second polarizer on the image source do not overlap with each other.

In one embodiment, the first light beam is a light beam incident at a positive angle and the second light beam is a light beam incident at a negative angle.

In one embodiment, the first in-coupling device and the second in-coupling device are arranged on opposite sides of the waveguide and are aligned coaxially with an optical axis.

In one embodiment, the out-coupling device includes:

a first out-coupling device, arranged on one side of the waveguide adjacent to the image source, and the first out-coupling device being configured to couple out the first light beam propagating in the waveguide; and

a second out-coupling device, arranged on one side of the waveguide away from the first out-coupling device, and the second out-coupling device being configured to couple out the second light beam propagating in the waveguide.

In one embodiment, the first in-coupling device and the first out-coupling device are transmission gratings, and the second in-coupling device and the second out-coupling device are reflection gratings; the first light beam is coupled into the waveguide through the first in-coupling device, totally reflected in the waveguide and transmitted to the first out-coupling device, and then coupled out by the first out-coupling device; and the second light beam is coupled into the waveguide through the second in-coupling device, totally reflected in the waveguide and transmitted to the second out-coupling device, and then coupled out to the preset area through the second out-coupling device and the first out-coupling device sequentially.

In one embodiment, the first out-coupling device and the second out-coupling device are arranged on opposite sides of the waveguide and are aligned coaxially with an optical axis.

In one embodiment, the out-coupling grating vector of the first light beam is the same as the out-coupling grating vector of the second light beam and has the same polarization selectivity. The out-coupling device is a transmission grating arranged on one side of the waveguide, and the single out-coupling device is arranged on either side in a thickness direction of the waveguide.

In the above waveguide augmented reality display apparatus, the single waveguide is spaced from the image source. Since the first in-coupling device and the second in-coupling device respectively arranged on both sides of the single waveguide may only diffract the first beam and the second beam generated by the image source according to the data of the displayed image, the first beam and the second beam generated by the image source may be coupled into the waveguide through the first in-coupling device and the second in-coupling device respectively. Then, the first light beam and the second light beam propagating in the waveguide are coupled out in the same preset area through the out-coupling device arranged on the waveguide, so that the above waveguide augmented reality display apparatus can realize superposition and doubling of two different fields of view composed of the first light beam and the second light beam through the single waveguide. Compared with the traditional waveguide augmented reality display apparatus with dual-waveguide, the present solution can significantly increase the field of view on the premise of ensuring the compact structure of the waveguide augmented reality display apparatus, which is conducive to improving the user experience.

### BRIEF DESCRIPTION OF THE DRAWINGS

FIG. 1 is a schematic diagram of a principle of a traditional waveguide augmented reality display apparatus;

FIG. 2 is a schematic diagram of an overall optical path of a waveguide augmented reality display apparatus in an embodiment of the present disclosure;

FIG. 3 is a schematic diagram of an optical path of a first light beam in a waveguide augmented reality display apparatus in an embodiment of the present disclosure;

FIG. 4 is a schematic diagram of an optical path of a second light beam in a waveguide augmented reality display apparatus in an embodiment of the present disclosure;

FIG. 5 is a schematic diagram of an overall optical path of a waveguide augmented reality display apparatus in another embodiment of the present disclosure;

FIG. 6 is a schematic diagram of a light beam projection in an embodiment of the present disclosure;

FIG. 7 is a schematic diagram of a grating vector in which a first light beam and a second light beam are respectively coupled into, deflected and coupled out of a waveguide in an embodiment of the present disclosure.

### DETAILED DESCRIPTION

The present disclosure will be further illustrated with reference to the accompanying drawings and embodiments.

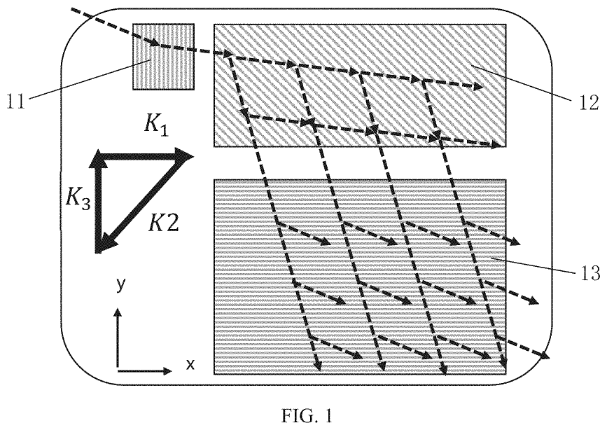

As shown in FIG. 1, a general waveguide augmented reality display apparatus includes a waveguide and an in-coupling device 11, a deflector 12 and an out-coupling device 13 mounted on the waveguide. The in-coupling device 11 is configured to couple a light beam into the waveguide. The deflector 12 is configured to change a transmission direction of the light beam in the waveguide while realizing an expansion of the light beam in an X direction. The out-coupling device 13 is configured to couple out the light beam propagating in the waveguide while realizing an exit pupil expansion of the light beam in a Y direction. The in-coupling device 11, the deflector 12 and the out-coupling device 13 may be holographic optical elements (HOE) or diffractive optical elements, including a volume holographic grating, a tilted grating and a blazed grating.

Specifically, for convenience of description, the corresponding grating vectors of the light beams in the in-coupling device 11, the deflector 12 and the out-coupling device 13 are respectively denoted as K₁, K₂ and K₃, and the corresponding propagation periods of the light beams in the in-coupling device 11, the deflector 12 and the out-coupling device 13 are respectively denoted as Λ₁, Λ₂ and Λ₃. The direction of the grating vector is parallel to a corresponding grating period direction;

The magnitude of K₁: |K₁|=2π/Λ₁;

The magnitude of K₂: |K₂|=2π/Λ₂; and

The magnitude of K₃: |K₃|=2π/Λ₃.

As shown in FIG. 1, the corresponding grating vectors K₁, K₂ and K₃ of the light beams in the in-coupling device 11, the deflector 12 and the out-coupling device 13 form a closed triangle, that is, K₁+K₂+K₃=0. In this case, the propagation direction of the light beam coupled into the waveguide is the same as that of the light beam coupled out of the waveguide.

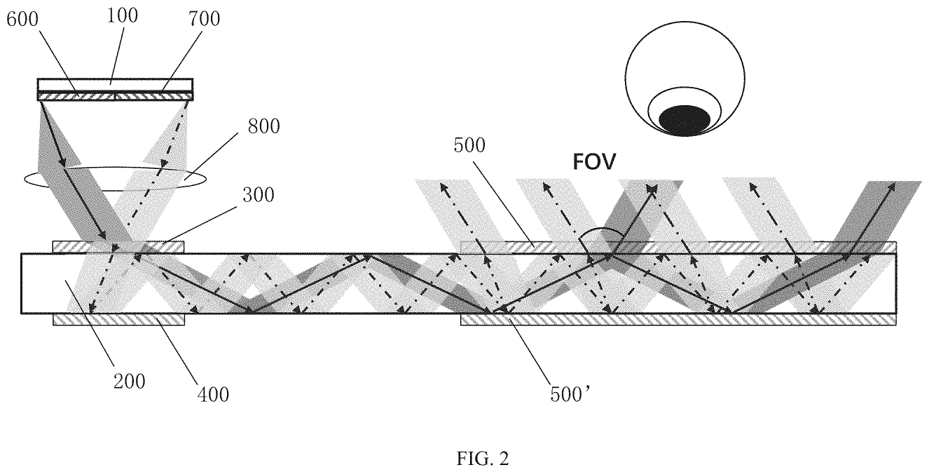

As shown in FIG. 2, a waveguide augmented reality display apparatus 10 in an embodiment of the present disclosure includes an image source 100, a waveguide 200, a first in-coupling device 300, a second in-coupling device 400 and an out-coupling device. In this embodiment, the out-coupling device includes a first out-coupling device 500 and a second out-coupling device 500′ located on opposite sides of the waveguide 200. The waveguide augmented reality display apparatus 10 of this embodiment does not have a deflector, but this does not affect the core idea of the present disclosure. In other embodiments of the present disclosure, a deflector may be arranged on a surface of the waveguide 200 to change a propagation of a light beam in the waveguide 200.

The image source 100 is configured to display an image and simultaneously generate a first light beam and a second light beam with different optical properties according to data of the displayed image. The waveguide 200 is spaced from the image source 100, and there is one waveguide 200. The first in-coupling device 300 is arranged on one side of the waveguide 200 adjacent to the image source 100. The first in-coupling device 300 is preferably a transmission grating, and is configured to couple the first light beam into the waveguide 200. The second in-coupling device 400 is arranged on the side of the waveguide 200 away from the image source 100. The second in-coupling device 400 is preferably a reflection grating, and is configured to couple the second light beam into the waveguide 200. Both the first light beam and the second light beam originate from a light beam generated by the image source 100 according to the data of the same displayed image. The out-coupling devices 500 and 500′ are arranged on the waveguide 200, and are configured to couple out the first light beam and the second light beam propagating in the waveguide 200 in a same preset area.

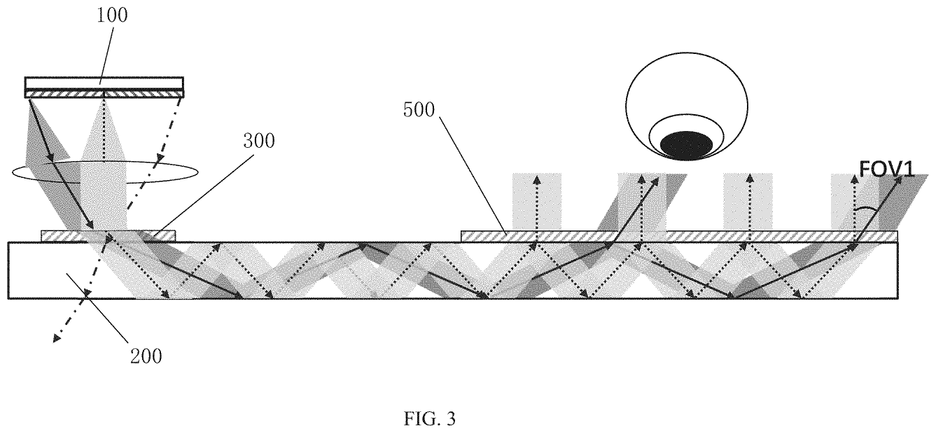

As shown in FIG. 3, taking a propagation path of the first light beam in the single waveguide 200 as an example, the first in-coupling device 300 is arranged on the side of the waveguide 200 adjacent to the image source 100. Since the first in-coupling device 300 arranged on the side of the waveguide 200 adjacent to the image source 100 is optically selective, the first in-coupling device 300 may only diffract the first light beam generated by the image source 100 according to the image data of the displayed image, and may not diffract the second beam generated by the image source 100 simultaneously according to the image data of the displayed image. Therefore, finally, the first in-coupling device 300 may only couple the first light beam generated by the image source 100 into the waveguide 200. The first light beam in the waveguide 200 is totally reflected and transmitted to the first out-coupling device 500, and then the first light beam propagating in the waveguide 200 is coupled out through the first out-coupling device 500 arranged on the waveguide 200.

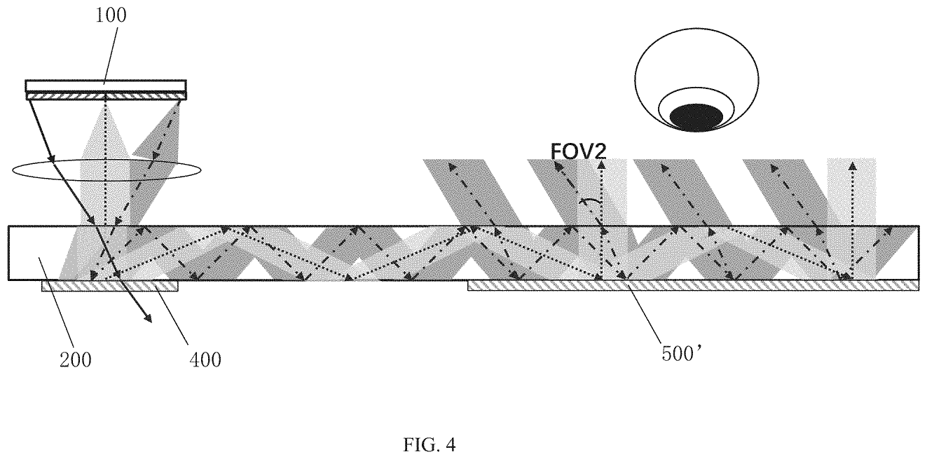

As shown in FIG. 4, taking a propagation path of the second light beam in the single waveguide 200 as an example, the second in-coupling device 400 is arranged on the side of the waveguide 200 away from the image source 100. Since the second in-coupling device 400 arranged on the side of the waveguide 200 away from the image source 100 is optically selective, the second in-coupling device 400 may only diffract the second light beam generated by the image source 100 according to image data of the displayed image, and may not diffract the first light beam generated by the image source 100 simultaneously according to the image data displayed image. Therefore, finally, the second in-coupling device 400 may only couple the second light beam generated by the image source 100 into the waveguide 200, and then the second light beam propagating in the waveguide 200 is coupled out through the second out-coupling device 500′ arranged on the waveguide 200. Specifically, the second light beam is coupled into the waveguide 200 through the second in-coupling device 400, totally reflected and transmitted in the waveguide 200 to the second out-coupling device 500′, and then coupled out to the preset area by the second out-coupling device 500′. Preferably, the second in-coupling device 400 and the second out-coupling device 500′ are reflection gratings. Referring to FIG. 2, a structure in this embodiment in which the first in-coupling device 300 is arranged on the side of the single waveguide 200 adjacent to the image source 100 and the second in-coupling device 400 is arranged on the side of the single waveguide 200 away from the image source 100 is analyzed. Since the first in-coupling device 300 and the second in-coupling device 400 respectively arranged on two sides of the single waveguide 200 may only respectively diffract the first light beam and the second light beam generated by the image source 100 according to the image data of the displayed image, finally, the first light beam and the second light beam generated by the image source 100 may be coupled into the waveguide 200 through the first in-coupling device 300 and the second in-coupling device 400 respectively, and then the first light beam and the second light beam propagating in the waveguide 200 are coupled out in the same preset area through the first out-coupling device 500 and the second out-coupling device 500′ arranged on the waveguide 200. In this way, the above-described waveguide augmented reality display apparatus 10 may realize a superposition of two different fields of view composed of the first light beam and the second light beam through the single waveguide 200. Compared with the traditional waveguide augmented reality display apparatus with dual-waveguide, the present solution can significantly increase the field of view on the premise of ensuring a compact structure of the waveguide augmented reality display apparatus 10, which is conducive to improving the user experience.

As shown in FIG. 2, in an embodiment, the image source 100 may be a display. Further, the first in-coupling device 300 and the second in-coupling device 400 are arranged on opposite sides of the waveguide 200 and are aligned coaxially with an optical axis. Specifically, the first in-coupling device 300 and the second in-coupling device 400 are arranged on opposite sides of the waveguide 200 in a thickness direction and are aligned coaxially with an optical axis.

In an embodiment, the first light beam is a light beam of a first polarization state, and the second light beam is a light beam of a second polarization state. That is, in the present solution, the light beams generated by the image source 100 according to the data of the displayed image are the light beam of the first polarization state and the light beam of the second polarization state with different polarization states. As shown in FIG. 1, the waveguide augmented reality display apparatus 10 further includes a first polarizer 600 and a second polarizer 700. The first polarizer 600 and the second polarizer 700 are configured to screen the light beams generated by the image source 100 according to the data of the displayed image, to obtain the light beam of the first polarization state and the light beam of the second polarization state respectively. In this embodiment, the first in-coupling device 300 is a transmission grating with a polarization selectivity, which may only diffract the light beam of the first polarization state for coupling the light beam of the first polarization state into the waveguide 200. The second in-coupling device 400 is a reflection grating with the polarization selectivity, which may only diffract the light beam of the second polarization state for coupling the light beam of the second polarization state into the waveguide 200. The first out-coupling device 500 with the same polarization selectivity as the first in-coupling device 300, and the second out-coupling device 500′ with the same polarization selectivity as the second in-coupling device 400, are respectively configured to couple out the light beam of the first polarization state and the light beam of the second polarization state propagating in the waveguide 200 in the same preset area.

As shown in FIG. 2, further, the first polarizer 600 and the second polarizer 700 are arranged in parallel on one side of the image source 100 adjacent to the waveguide 200, and the orthographic projections of the first polarizer 600 and the second polarizer 700 on the image source 100 do not overlap with each other. Specifically, the first polarizer 600 and the second polarizer 700 cover an entire bottom of the image source 100 to ensure that all light beams generated by the image source 100 according to the data of the displayed image may be screened through the first polarizer 600 and the second polarizer 700.

Further, in an embodiment, the light beam of the first polarization state and the light beam of the second polarization state are a light beam of an S polarization state and a light beam of a P polarization state, respectively. It can be appreciated that in other embodiments, the light beam of the first polarization state and the light beam of the second polarization state may be a light beam of a left-handed circular polarization state and a light beam of a right-handed circular polarization state, respectively.

As shown in FIG. 2, in an embodiment, when the first light beam and the second light beam are coupled out, due to their different polarization selectivity, the first out-coupling device 500 and the second out-coupling device 500′ are configured to couple out the first light beam and the second light beam propagating in the waveguide 200 in the same preset area, respectively. Specifically, the first out-coupling device 500 and the second out-coupling device 500′ are arranged on opposite sides of the waveguide 200 and are aligned coaxially with an optical axis. Further, the first out-coupling device 500 and the second out-coupling device 500′ are arranged on opposite sides of the waveguide 200 in a thickness direction and are aligned coaxially with an optical axis.

It can be appreciated that when the out-coupling gratings of the first beam and the second beam have the same polarization selectivity, a single out-coupling device is configured to couple out the first beam and the second beam propagating in the waveguide 200 in the same preset area. Specifically, the single out-coupling device is the transmission grating and is arranged on either side of the waveguide 200 in the thickness direction. In this embodiment, the single out-coupling device is arranged on the side of the waveguide 200 adjacent to the image source 100.

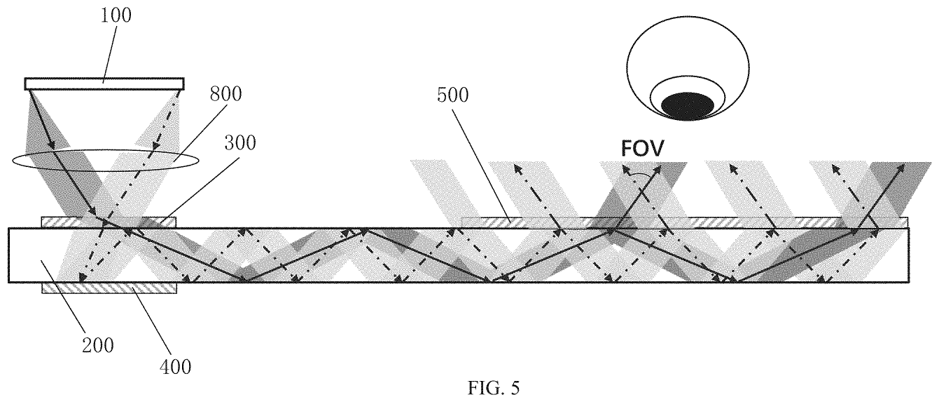

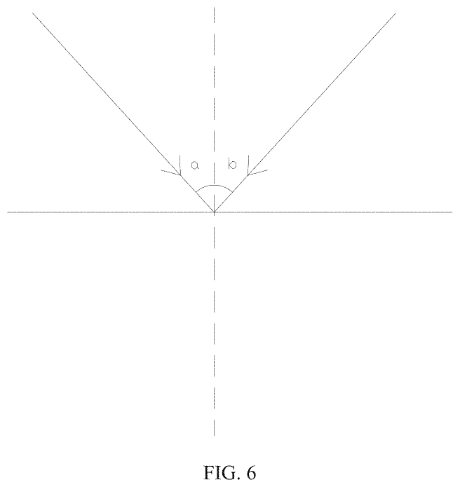

As shown in FIG. 5, specifically, in another embodiment, the first beam is a beam incident at a positive angle, and the second beam is a beam incident at a negative angle. That is, in the present solution, the light beam generated by the image source 100 according to the data of the displayed image may be a light beam of polarization state or a light beam of non-polarization state. The present solution does not require the polarization state of the light beam generated by the image source 100 according to the data of the displayed image. For convenience of understanding, the positive angle is defined as angle a in FIG. 6, and the negative angle is defined as angle b in FIG. 6.

Since the first in-coupling device 300 and the second in-coupling device 400 respectively arranged on both sides of the single waveguide 200 have a limited angular bandwidth, they may only respectively diffract the first light beam (the light beam incident at the positive angle) and the second light beam (the light beam incident at the negative angle) generated by the image source 100 according to the data of the displayed image. Therefore, the light beam generated by the image source 100 and incident at the positive angle may be coupled into the waveguide 200 through the first in-coupling device 300 on the side of the single waveguide 200 adjacent to the image source 100, while the light beam generated by the image source 100 and incident at the negative angle may be coupled into the waveguide 200 through the second in-coupling device 400 on the side of the single waveguide 200 away from the image source 100. Finally, the light beam incident at the positive angle and the light beam incident at the negative angle propagating in the waveguide 200 are coupled out in the same preset area by the out-coupling device 500. The out-coupling device 500 has a large angular bandwidth and may couple out the first beam and the second beam at the same time. In this way, the above waveguide augmented reality display apparatus 10 can realize the superposition of two different fields of view composed of the light beam incident at the positive angle and the light beam incident at the negative angle through the single waveguide 200, and significantly increase the field of view on the premise of ensuring the compact structure of the waveguide augmented reality display apparatus 10.

As shown in FIG. 2, further, in an embodiment, the above waveguide augmented reality display apparatus 10 further includes a collimator 800 arranged between the image source 100 and the waveguide 200. The collimator 800 is configured to process the first light beam and the second light beam into a collimated light.

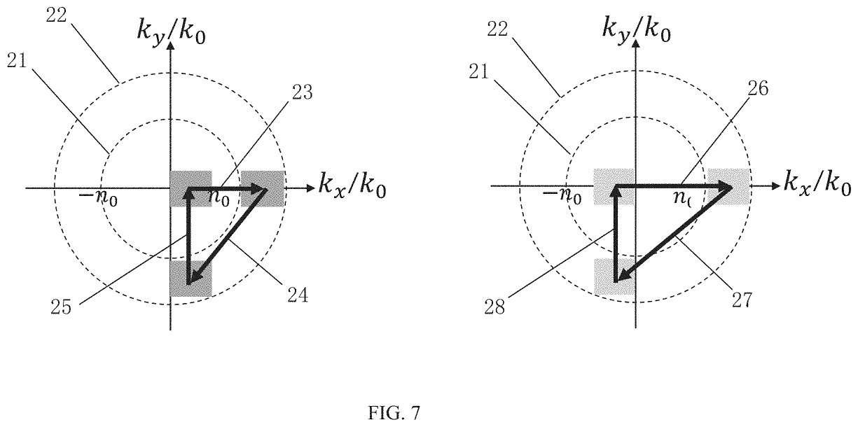

As shown in FIG. 7, for the waveguide augmented reality display apparatus 10 in this embodiment, a refractive index of air is defined as n₀, and a refractive index of the waveguide 200 is defined as n₁. An inner imaginary circle 21 in a wave vector space diagram is a boundary of a total internal reflection (TIR) of the light beams in the waveguide 200. A rectangular frame represents a distribution range of the light beams displaying the image in the wave vector space. In this embodiment, the light beams are the first light beam and the second light beam with different optical properties. The condition for the total internal reflection of the light beam in the waveguide 200 is: kₓ²+k_{y}²>k₀², so a radius of the inner imaginary circle 21 is n₀. An outer imaginary circle 22 is a boundary of an exit pupil continuity of the light beam, and a radius of the outer imaginary circle 22 is less than n₁. A grating vector provided by the in-coupling grating may move the light beam (rectangle) of the image in the air from a center of the wave vector space to a space between the radius of the inner imaginary circle 21 and the outer imaginary circle 22, indicating that the light beam of the image may be completely coupled into the waveguide 200.

Specifically, the grating vectors corresponding to the first light beam in the first in-coupling device 300, the deflector and the out-coupling devices 500 and 500′ are respectively a first solid line with arrow 23, a second solid line with arrow 24 and a third solid line with arrow 25 shown in FIG. 7. The grating vectors corresponding to the second beam in the second in-coupling device 400, the waveguide 200 and the out-coupling device 500 are respectively a fourth solid line with arrow 26, a fifth solid line with arrow 27 and a sixth solid line with arrow 28 shown in FIG. 4. In the present solution, a sum of the grating vectors corresponding to the first beam in the first in-coupling device 300, the deflector and the out-coupling devices 500 and 500′ and a sum of the grating vectors corresponding to the second beam in the second in-coupling device 400, the waveguide 200 and the out-coupling device 500 are both zero.

In the above waveguide augmented reality display apparatus 10, the waveguide 200 is spaced from the image source 100, and the waveguide 200 is a single. Since the first in-coupling device 300 and the second in-coupling device 400 respectively arranged on both sides of the single waveguide 200 may only diffract the first beam and the second beam generated by the image source 100 according to the data of the displayed image, then the first beam and the second beam generated by the image source 100 may be coupled into the waveguide 200 through the first in-coupling device 300 and the second in-coupling device 400 respectively. Then, the first light beam and the second light beam propagating in the waveguide 200 are coupled out in the same preset area through the out-coupling devices 500 and 500′ arranged on the waveguide 200, so that the above waveguide augmented reality display apparatus 10 can realize superposition of two different fields of view composed of the first light beam and the second light beam through the single waveguide 200. Compared with the traditional waveguide augmented reality display apparatus with dual-waveguide, the present solution can significantly increase the field of view on the premise of ensuring the compact structure of the waveguide augmented reality display apparatus 10, which is conducive to improving the user experience.

The above is merely embodiments of the present disclosure. It should be appreciated that, those of ordinary skills in the art may make improvements without departing from the inventive concept of the present disclosure, such improvements, however, fall within the protection scope of the present disclosure.

What is claimed is:

1. A waveguide augmented reality display apparatus, comprising:
an image source, configured to display an image and generate a first light beam and a second light beam with different optical properties according to data of the displayed image;
a single waveguide, being spaced from the image source;
a first in-coupling device, arranged on one side of the waveguide adjacent to the image source, and configured to couple the first light beam into the waveguide;
a second in-coupling device, arranged on one side of the waveguide away from the image source, and configured to couple the second light beam into the waveguide, wherein both the first light beam and the second light beam are originated from a light beam generated by the image source according to data of a same displayed image; and
an out-coupling device, arranged on the waveguide, and configured to couple out the first light beam and the second light beam propagating in the waveguide in a same preset area; wherein an out-coupling grating vector of the first light beam and an out-coupling grating vector of the second light beam are the same.

2. The waveguide augmented reality display apparatus according to claim 1, wherein the first light beam is a light beam of a first polarization state, the second light beam is a light beam of a second polarization state, the waveguide augmented reality display apparatus further comprises a first polarizer and a second polarizer, and the first polarizer and the second polarizer are configured to screen the light beam to obtain a light beam of the first polarization state and a light beam of the second polarization state respectively.

3. The waveguide augmented reality display apparatus according to claim 2, wherein the light beam of the first polarization state and the light beam of the second polarization state are a light beam of an S polarization state and a light beam of a P polarization state, or a light beam of a left-handed circular polarization state and a light beam of a right-handed circular polarization state, respectively.

4. The waveguide augmented reality display apparatus according to claim 3, wherein the first polarizer and the second polarizer are arranged in parallel on one side of the image source adjacent to the waveguide, and an orthographic projection of the first polarizer and an orthographic projection of the second polarizer on the image source do not overlap with each other.

5. The waveguide augmented reality display apparatus according to claim 1, wherein the first light beam is a light beam incident at a positive angle and the second light beam is a light beam incident at a negative angle.

6. The waveguide augmented reality display apparatus according to claim 1, wherein the first in-coupling device and the second in-coupling device are arranged on opposite sides of the waveguide and are aligned coaxially with an optical axis.

7. The waveguide augmented reality display apparatus according to claim 1, wherein the out-coupling device comprises:
a first out-coupling device, arranged on one side of the waveguide adjacent to the image source, and the first out-coupling device being configured to couple out the first light beam propagating in the waveguide; and
a second out-coupling device, arranged on one side of the waveguide away from the first out-coupling device, and the second out-coupling device being configured to couple out the second light beam propagating in the waveguide.

8. The waveguide augmented reality display apparatus according to claim 7, wherein the first in-coupling device and the first out-coupling device are transmission gratings, and the second in-coupling device and the second out-coupling device are reflection gratings;
the first light beam is coupled into the waveguide through the first in-coupling device, totally reflected in the waveguide and transmitted to the first out-coupling device, and then coupled out by the first out-coupling device; and
the second light beam is coupled into the waveguide through the second in-coupling device, totally reflected in the waveguide and transmitted to the second out-coupling device, and then coupled out to the preset area through the second out-coupling device and the first out-coupling device sequentially.

9. The waveguide augmented reality display apparatus according to claim 8, wherein the first out-coupling device and the second out-coupling device are arranged on opposite sides of the waveguide and are aligned coaxially with an optical axis.

10. The waveguide augmented reality display apparatus according to claim 1, wherein the out-coupling device is a transmission grating arranged on one side of the waveguide, and the single out-coupling device is arranged on either side in a thickness direction of the waveguide.
